(19) United States
(12) Patent Application Publication
(10) Pub. No.: US 2007/0039183 A1
(43) Pub. Date: Feb. 22, 2007

(54) Method of assembly and dual-sided seat recliner assembly

(76) Inventors: Dagoberto Krambeck, Troy, MI (US); Alfred J. Fisher JR., Grosse Pointe, MI (US)

Correspondence Address: HARNESS, DICKEY & PIERCE, P.L.C., P.O. BOX 828, BLOOMFIELD HILLS, MI, 48303, US

(21) Appl. No.: 11/504,971

(22) Filed: Aug. 16, 2006

Related U.S. Application Data
(60) Provisional application No. 60/708,984, filed on Aug. 17, 2005.

(51) Int. Cl. B23Q 17/00

(52) U.S. Cl. 29/897.2; 29/428; 29/407.1

(57) ABSTRACT

A method of assembling a dual recliner mechanism includes positioning a first recliner mechanism, positioning a second recliner mechanism relative to the first recliner mechanism, assembling a first member of a cross rod to the first recliner mechanism, assembling a second member of the cross rod to the second recliner mechanism, adjusting a relative position between the first member and the second member, and fixing the first member to the second member to maintain the relative position.

### CROSS-REFERENCE TO RELATED APPLICATIONS

This application claims the benefit of U.S. Provisional Application No. 60/708,984, filed on Aug. 17, 2005. The disclosure of the above application is incorporated herein by reference.

### FIELD

The present teachings relate to recliner mechanisms and, more particularly, to a dual recliner mechanism.

### BACKGROUND

Seat assemblies, such as those used in vehicles, generally include an inboard recliner mechanism and an outboard recliner mechanism that cooperate to allow selective rotation of a seatback relative to a seat bottom. The outboard mechanism is usually tied to a manual lever or a power-actuated lever such that when a force is applied to the lever, the outboard mechanism is released. The rotational force applied to the outboard mechanism rotates a cross rod that extends generally between the outboard mechanism and the inboard mechanism. Rotation of the cross rod causes the inboard mechanism to similarly release. Once the outboard and inboard recliner mechanisms are released, the seatback is permitted to rotate relative to the seat bottom.

Release of the inboard mechanism is typically not simultaneous with the release of the outboard mechanism. Generally, the outboard recliner mechanism is released first with the inboard recliner mechanism being released a predetermined time after release of the outboard mechanism. To achieve release of the inboard recliner mechanism a predetermined time after release of the outboard mechanism, the inboard mechanism must be synchronized with the outboard mechanism.

Conventional dual recliner mechanism accomplish synchronization of the inboard mechanism with the outboard mechanism by maintaining tight tolerances on the cross rod and internal components associated with the outboard and inboard recliner mechanisms. The tight tolerances help properly align the outboard recliner mechanism, inboard recliner mechanism, and cross rod such that a desired release timing of each mechanism is achieved.

Maintaining tight tolerances on the outboard and inboard recliner mechanisms is a difficult task and often results in increasing the release efforts required to manipulate the mechanisms into the released position. Furthermore, when the recliner mechanisms and cross rod are assembled to a vehicle seat, any discrepancy in construction of the seat further complicates achieving the desired synchronization of the inboard recliner mechanism with the outboard recliner mechanism.

### SUMMARY

A method of assembling a dual recliner mechanism includes positioning a first recliner mechanism, positioning a second recliner mechanism relative to the first recliner mechanism, assembling a first member of a cross rod to the first recliner mechanism, assembling a second member of the cross rod to the second recliner mechanism, adjusting a relative position between the first member and the second member, and fixing the first member to the second member to maintain the relative position.

A dual recliner mechanism includes a first recliner mechanism, a second recliner mechanism, a first member attached to the first recliner mechanism, and a second member attached to the second recliner mechanism and adjustably attached to the first member to define a position of the first recliner mechanism relative to the second recliner mechanism.

Further areas of applicability of the present teachings will become apparent from the detailed description provided hereinafter. It should be understood that the detailed description and specific examples are intended for purposes of illustration only and are not intended to limit the scope of the teachings.

### BRIEF DESCRIPTION OF THE DRAWINGS

The present teachings will become more fully understood from the detailed description and the accompanying drawings, wherein:

FIG. 1 is a perspective view of a seat assembly incorporating a dual recliner mechanism including a two-piece cross rod in a pre-assembled state in accordance with the principles of the present teachings;

FIG. 2 is a perspective view of a seat assembly incorporating a dual recliner mechanism including a two-piece cross rod in an assembled state in accordance with the principles of the present teachings;

FIG. 3 is a side view of the cross rod of FIG. 1 in the pre-assembled state;

FIG. 4 is a side view of the cross rod of FIG. 2 in the assembled state;

FIG. 5 is a perspective view of the cross rod of FIG. 2 partially sectioned to show the relationship between each member of the cross rod in the assembled state;

FIG. 6 is a perspective view of a crimp tool for use in assembling the cross rod of FIGS. 1 and 2;

FIG. 7 is a perspective view of an assembly fixture incorporating the crimp tool of FIG. 6; and

FIG. 8 is a perspective view of an assembly station incorporating the assembly fixture of FIG. 7 showing the assembly fixture in a use position and a retracted position.

### DETAILED DESCRIPTION

The following description is merely exemplary in nature and is in no way intended to limit the teachings, application, or uses.

With reference to the figures, a dual recliner mechanism 10 is provided and includes an outboard recliner mechanism 12, an inboard recliner mechanism 14, and a cross rod 16. The cross rod 16 extends generally between the outboard recliner mechanism 12 and the inboard recliner mechanism 14 and transmits a rotational force form the outboard recliner mechanism 12 to the inboard recliner mechanism 14 to allow communication between the recliner mechanisms 12, 14. During manufacturing, the cross rod 16 permits adjustment of the relative position of the outboard recliner mechanism 12 and the inboard recliner mechanism 14 and achieves a desired synchronization between the inboard recliner mechanism 14 and the outboard recliner mechanism 12.

The outboard recliner mechanism 12 may include a locking mechanism 18 disposed generally between a first housing plate 20 and a second housing plate 22 that selectively prevents rotation of the first housing plate 20 relative to the second housing plate 22. The inboard recliner mechanism 14 may also include a locking mechanism 24 disposed generally between a first housing plate 26 and a second housing plate 28 that similarly selectively prevents rotation of the first housing plate 26 relative to the second housing plate 28.

An actuation mechanism 30 may be associated with either the outboard recliner mechanism 12 or the inboard recliner mechanism 14 and may include an actuation handle 32. The actuation handle 32 may be supported by the outboard recliner mechanism 12 such that rotation of the actuation handle 32 causes disengagement of the locking mechanism 18. Similarly, the actuation handle 32 may be supported by the inboard recliner mechanism 14 such that rotation of the actuation handle 32 causes disengagement of the locking mechanism 24.

Disengagement of the locking mechanism 18 permits rotation of the first housing plate 20 relative to the second housing plate 22. Similarly, disengagement of the locking mechanism 24 permits rotation of the first housing plate 26 relative to the second housing plate 28. While the actuation mechanism 30 may be associated with either the outboard recliner mechanism 12 or the inboard recliner mechanism 14, the actuation mechanism 30 will hereinafter be described and shown in the drawings as being associated with the outboard recliner mechanism 12. Furthermore, while an actuation handle 32 is disclosed, it should be understood that the actuation mechanism 30 may alternatively, or additionally, include a powered mechanism and may therefore be remotely actuated.

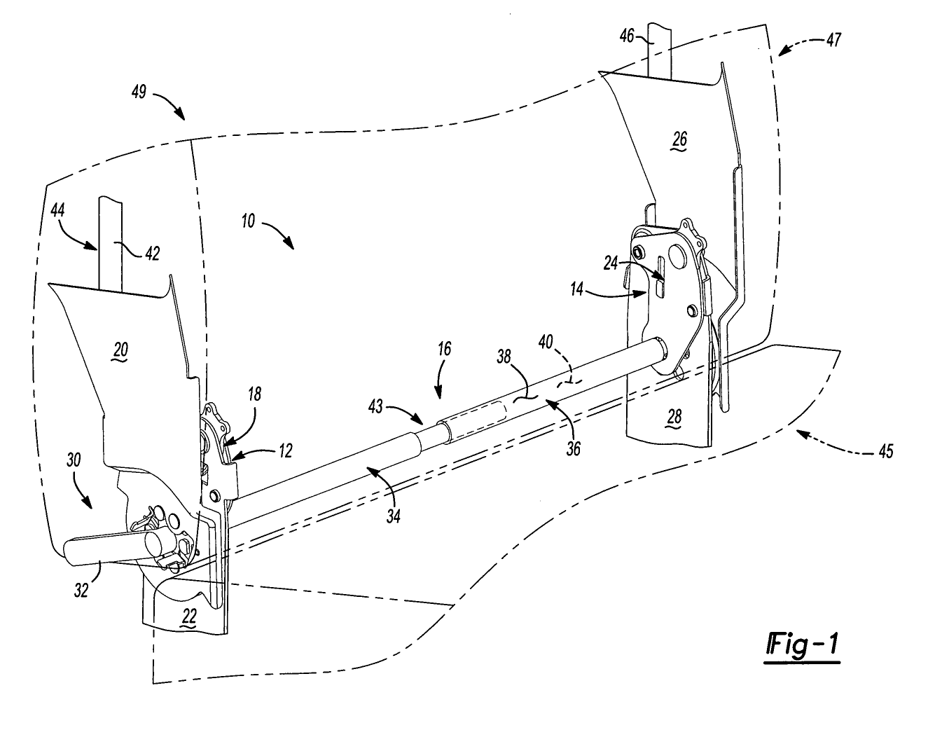

With particular reference to FIGS. 1-5, the cross rod 16 includes a first rod member 34 and a second rod member 36. The first rod member 34 may be associated with the outboard recliner mechanism 12 such that rotation of the actuation handle 32 causes rotation of the first rod member 34. An end of the first rod member 34 may be spaced apart from an outer surface of the outboard recliner mechanism 12 to permit transverse movement of the first rod member 34 relative to the outboard recliner mechanism 12.

The second rod member 36 may be associated with the inboard recliner mechanism 14 such that rotation of the second rod member 36 by the first rod member 34 causes disengagement of the locking mechanism 24. An end of the second rod member 36 may be spaced apart from an outer surface of the inboard recliner mechanism 14 to permit transverse movement of the second rod member 36 relative to the inboard recliner mechanism 14. The first rod member 34 may include a cross-section having a hexagonal, double-D, square, spline, or thru shaft construction while the second rod member 36 may include a generally cylindrical shape having an outer surface 38 and an inner surface 40.

While the first rod member 34 is described as including a cross-section having a hexagonal, double-D, square, spline, or thru shaft construction, that the first rod member 34 may be constructed of any suitable cross section having at least one flat, key, or spline. Furthermore, while the first rod member 34 is described as including at least one flat, key, or spline, and the second rod member 36 is described as being generally cylindrical, that the first rod member 34 may alternatively be generally cylindrical and the second rod member 36 may alternatively include at least one flat, key, or spline. Further yet, each rod member 34, 36 may be generally cylindrical or may include at least one flat, key, or spline.

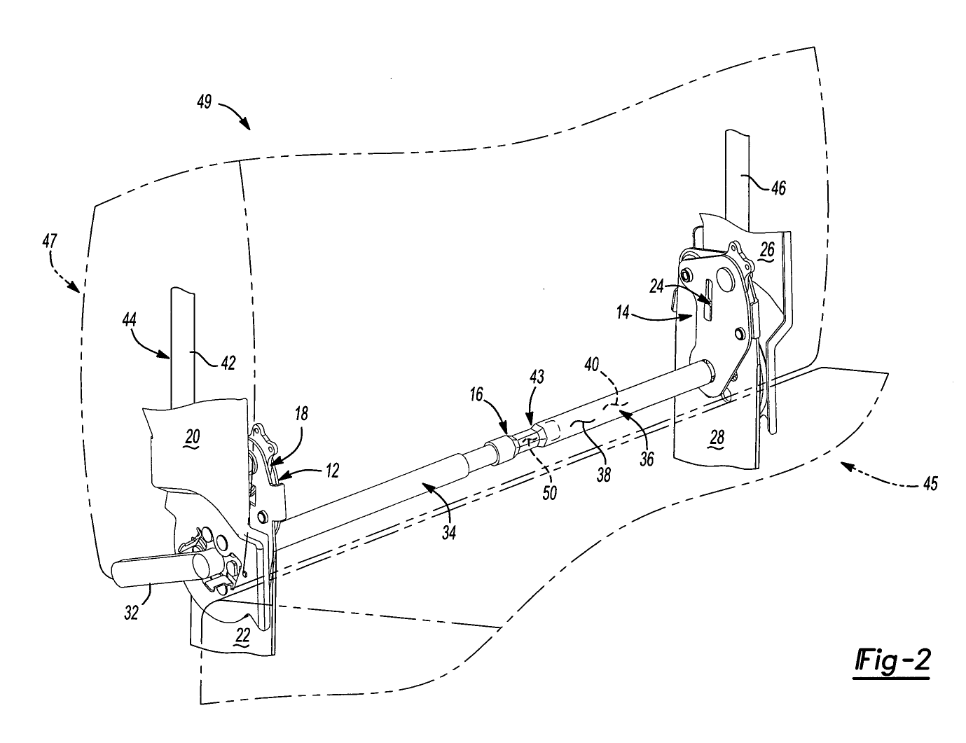

The inner surface 40 of the second rod member 36 slidably and rotatably receives the first rod member 34 such that the first rod member 34 is permitted to telescope within the second rod member 36 (FIGS. 1 and 2). A crimp zone 43 is created generally at the interface of the first rod member 34 and the second rod member 36.

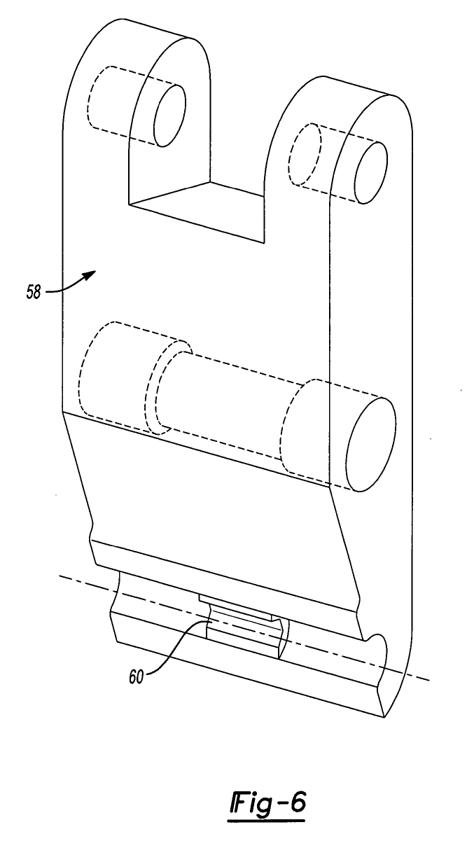

With reference to FIGS. 1-8, a manufacturing process for assembling the cross rod 16 to the inboard and outboard recliner mechanisms 12, 14 will be described in detail. During manufacturing, the outboard recliner mechanism 12 may be attached to a first portion 42 of a seat frame 44 and the inboard recliner mechanism 14 may attached to a second portion 46 of the seat frame 44.

Once the inboard and outboard recliner mechanisms 12, 14 are assembled to the seat frame 44, the first rod member 34 is attached to the outboard recliner mechanism 12 and the second rod member 36 is attached to the inboard recliner mechanism 14. At this point, the position of the outboard recliner mechanism 12 relative to the inboard recliner mechanism 14 is adjustable as the first rod member 34 is permitted to telescope within the second rod member 36.

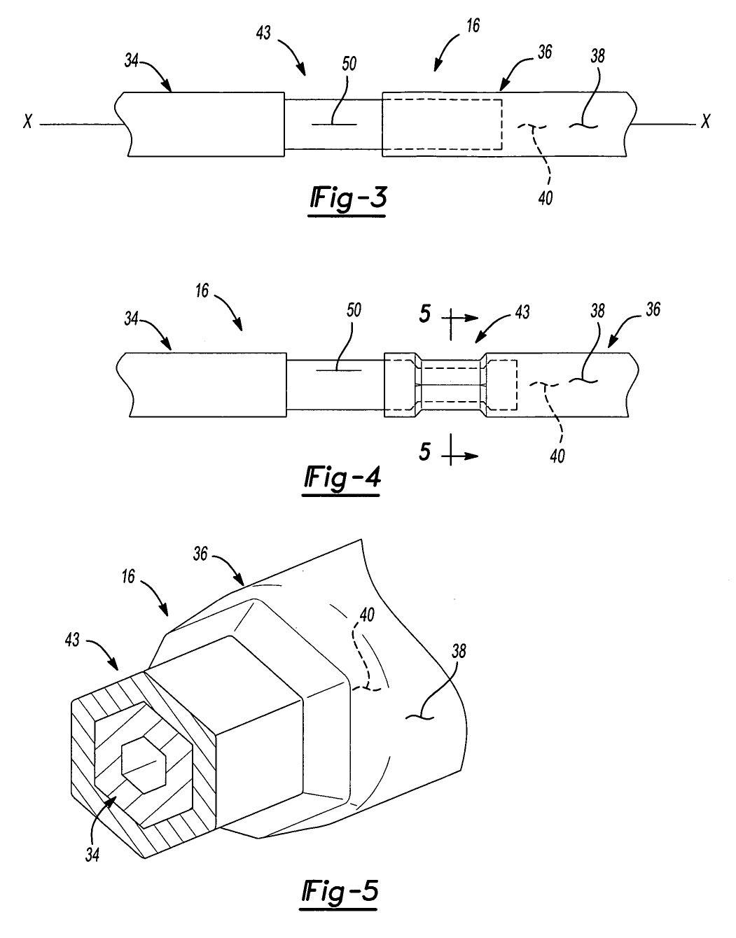

The first rod member 34 is positioned along a longitudinal axis “X” (FIG. 3) relative to the second rod member 36 until a desired position of the outboard recliner mechanism 12 relative to the inboard recliner mechanism 14 is achieved. Once the desired relative position between the outboard recliner mechanism 12 and the inboard recliner mechanism 14 is achieved (i.e., the distance between the outboard recliner mechanism 12 and the inboard recliner mechanism 14), the position of the first rod member 34 relative to the second rod member 36 is held constant. It should be understood that while the first rod member 34 is described as moving relative to the second rod member 36 that the second rod member 36 may alternatively, or additionally, be moved along the longitudinal axis X to adjust the relative position of the outboard recliner mechanism 12 and the inboard recliner mechanism 14.

Once the longitudinal position of the first rod member 34 relative to the second rod member 36 is achieved, the recliner mechanisms 12, 14 are biased into an engaged position preventing rotation of the first housing plates 20, 26 relative to the second housing plates 22, 28 to time release of the inboard recliner mechanism 14 with the outboard recliner mechanism 12. In the engaged position, a seatback 47 of the seat assembly 49 is prevented from rotating relative to a seat bottom 45 by the locking mechanisms 18, 24 of the respective recliner mechanisms 12, 14. While the inboard recliner mechanism 14 is timed with the release of the outboard recliner mechanism 12, release of the outboard recliner mechanism 12 could alternatively be timed with the release of the inboard recliner mechanism 14.

Timing release of the inboard mechanism 14 with the outboard mechanism 12 includes aligning internal components of the outboard recliner mechanism 12 with internal components of the inboard recliner mechanism 14 to provide the inboard recliner mechanism 14 with a desired release time following release of the outboard recliner mechanism 12. Aligning internal components of the outboard recliner mechanism 12 with internal components of the inboard recliner mechanism 14 is accomplished by adjusting a radial position of the second rod member 36 relative to the first rod member 34 such that internal components of the inboard recliner mechanism 14 are rotated relative to the outboard recliner mechanism 12.

While rotation of the second rod member 36 relative to the first rod member 34 is described, rotation of the first rod member 34 relative to the second rod member 36 may alternatively be performed to adjust the internal components of the outboard recliner mechanism 12 relative to the inboard recliner mechanism 14 if the inboard recliner mechanism 14 is released before the outboard recliner mechanism 12 (i.e., if the actuation handle 32 is associated with the inboard recliner mechanism 14 rather than the outboard recliner mechanism 12, for example).

In operation, when a force is applied to the actuation handle 32, internal components of the locking mechanism 18 of the outboard recliner mechanism 12 are manipulated to release the outboard recliner mechanism 12. The rotational force applied to the actuation handle 32 is similarly applied to the cross rod 16 and causes the cross rod 16 to rotate as the outboard recliner mechanism 12 is released. The rotating cross rod 16 releases the inboard recliner mechanism 14 a predetermined time following release of the outboard recliner mechanism 12. As noted above, the actuation handle 32 could alternatively be associated with the inboard recliner mechanism 14 such that rotation of the actuation handle 32 releases the outboard mechanism 12 and subsequently releases the inboard mechanism 14 through rotation of the cross rod 16.

If internal components of the inboard recliner mechanism 14 are assembled without free play (i.e., to high tolerances) the inboard recliner mechanism 14 would release almost simultaneously with the outboard recliner mechanism 12 as even minuscule rotation of the cross rod 16 would cause release of the inboard recliner mechanism 14. However, internal components of each recliner mechanism 12, 14 typically include at least some free play due to tolerance stack up amongst the various components of each recliner mechanism 12, 14 and to help reduce the efforts required to release the recliner mechanisms 12, 14. Therefore, the amount of free play of the inboard recliner mechanism 14 generally dictates the release time of the inboard recliner mechanism 14. If the actuation handle 32 is associated with the inboard recliner mechanism 14, release of the outboard mechanism 12 will be dictated by the amount of free play in the outboard mechanism 12.

Adjustments to the cross rod 16 may be performed to either decrease or increase the time in which the inboard recliner mechanism 14 releases following release of the outboard recliner mechanism 12. Once the recliner mechanisms 12, 14 are in the locked position, and the relative distance between the two recliner mechanisms 12, 14 is set, the second rod member 36 may be rotated about the first rod member 34 to either increase or decrease free play in the inboard recliner mechanism 14.

Decreasing free play in the inboard recliner mechanism 14 decreases the time in which the inboard recliner mechanism 14 releases following release of the outboard recliner mechanism 12 as only slight rotation of the cross rod 16 is required to release the inboard recliner mechanism 14. Conversely, increasing the free play in the inboard recliner mechanism 14 increases the time in which the inboard recliner mechanism 14 releases following release of the outboard recliner mechanism 12 as the cross rod 16 must be rotated a greater distance to release the inboard recliner mechanism 14. Therefore, rotating the second rod member 36 about the first rod member 34 adjusts the time in which the inboard recliner mechanism 14 releases following release of the outboard recliner mechanism 12.

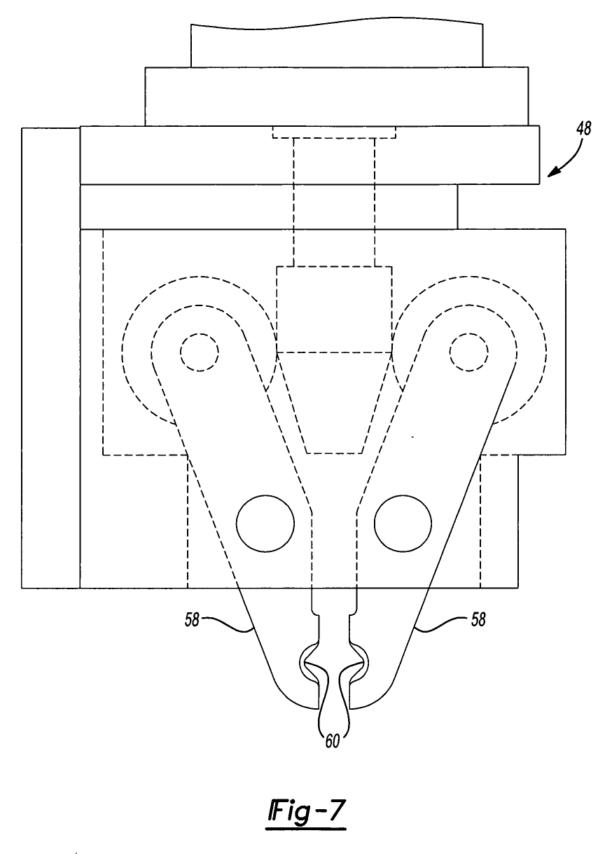

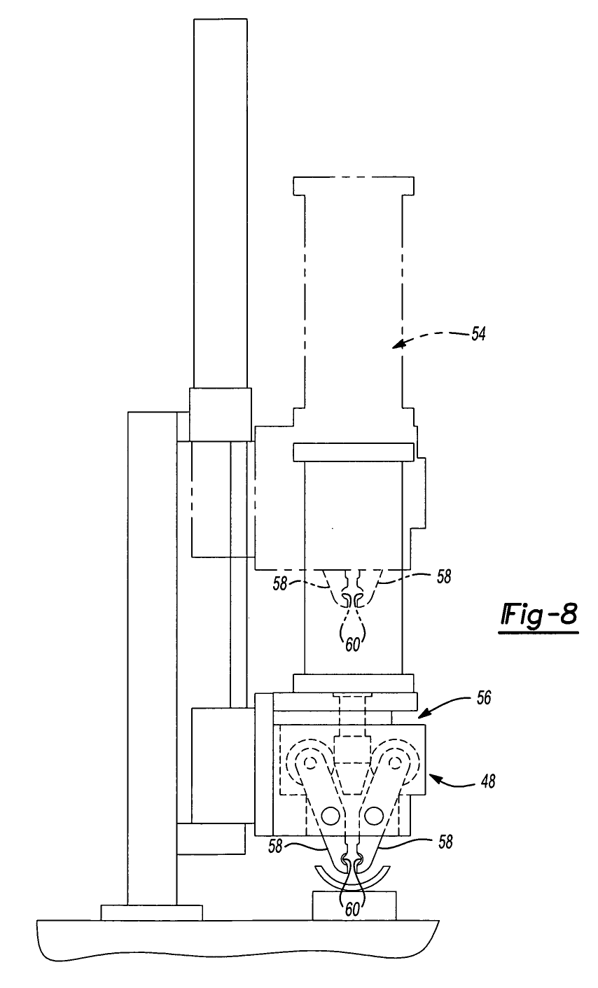

Once the second rod member 36 is in a desired rotational position relative to the first rod member 34, a crimp tool 48 (FIG. 7) applies a force to the outer surface 38 of the second rod member 36. The crimp tool 48 may be associated with an assembly station 52 (FIG. 8) that permits the crimp tool 48 to move axially relative to the crimp zone 43 between a retracted position 54 and an assembly position 56.

The force applied by the crimp tool 48 deforms the first and second rod members 34,36 and causes the inner surface 40 of the second rod member 36 to contact the first rod member 34 (FIG. 5). Contact between the deformed inner surface 40 of the second rod member 36 and the first rod member 34 fixes the rotational position of the second rod member 36 relative to the first rod member 34 and therefore fixes internal components of the outboard recliner mechanism 12 relative to internal components of the inboard recliner mechanism 14. The crimp tool 48 may include at least two halves 58 that cooperate to deform the first and second rod members 34, 36 in a plurality of locations to fix the first rod member 34 for rotation with the second rod member 36.

If the first rod member 34 includes a D-shape or includes a flat 50, the crimp tool 48 may position an engagement element 60 of one or both of the tool halves 58 on an outer surface 38 of the second rod member 36 such that the inner surface 40 of the second rod member 36 engages the flat 50 of the first rod member 34 once deformed. Contact between the deformed inner surface 40 of the second rod member 36 and the flat 50 of the first rod member 34 fixes the rotational position of the second rod member 36 relative to the first rod member 34.

Fixing the rotational position of the second rod member 36 similarly fixes the position of the internal components of the outboard recliner mechanism 12 relative to the internal components of the inboard recliner mechanism 14. Therefore, once the second rod member 36 is fixed to the first rod member 34, the inboard recliner mechanism 14 is synchronized with the outboard recliner mechanism 12.

In addition to the foregoing, the inboard and outboard recliner mechanisms 14, 12 may first be attached to a fixture (not shown) prior to being assembled to the seat frame 44 to set the relative distance between the recliner mechanisms 12, 14 and also synchronize the outboard recliner mechanism 12 with the inboard recliner mechanism 14.

For example, the inboard and outboard recliner mechanisms 14, 12 may be positioned on the fixture such that the relative distance between the two recliner mechanisms 12,14 is set. Once the recliner mechanisms 12,14 are assembled to the fixture, the cross rod 16 may be assembled to the recliner mechanisms 12, 14. The cross rod 16 is first adjusted such that the first rod member 34 telescopes within the second rod member 36 until a desired length of the cross rod 16 is achieved. Once the desired length of the cross rod 16 is achieved, the inboard recliner mechanism 14 may be synchronized with the outboard recliner mechanism 12 using the process outlined above.

The assembled dual recliner mechanism 10 may be attached to the seat frame 44 once the desired length of the cross rod 16, and the desired rotational position of the second rod member 36 relative to the first rod member 34, is achieved. If the dimensions of the seat frame 44 are slightly off, each of the first and second rod members 34, 36 may be moved closer to, or farther from, the inboard and outboard recliner mechanisms 14, 12 to accommodate the seat frame 44.

The description of the teachings is merely exemplary in nature and, thus, variations that do not depart from the gist of the teachings are intended to be within the scope of the teachings. Such variations are not to be regarded as a departure from the spirit and scope of the teachings.

What is claimed is:

1. A method comprising:
positioning a first recliner mechanism;
positioning a second recliner mechanism relative to said first recliner mechanism;
assembling a first member of a cross rod to said first recliner mechanism;
assembling a second member of said cross rod to said second recliner mechanism;
adjusting a relative position between said first member and said second member;
fixing said first member to said second member to maintain said relative position.

2. The method of claim 1, wherein said adjusting is based on coordination of movement of said first member relative to said second member.

3. The method of claim 1, wherein said adjusting includes adjusting a position of at least one of said first member and said second member.

4. The method of claim 1, wherein said adjusting includes adjusting a position of both of said first member and said second member.

5. The method of claim 1, wherein said adjusting a relative position includes adjusting a radial position.

6. The method of claim 1, wherein said adjusting a relative position includes adjusting a longitudinal position.

7. The method of claim 1, wherein said fixing includes crimping one of said first and second members to the other of said first and second members.

8. The method of claim 7, wherein said crimping includes applying a force to an outer surface of one of said first and second members until an inner surface is deformed and in contact with an engagement surface of the other of said first and second members.

9. The method of claim 8, wherein said engagement surface includes at least one flat.

10. The method of claim 1, further comprising positioning said first recliner mechanism and said second recliner mechanism in a locked position prior to said adjusting.

11. The method of claim 1, wherein said assembling said first member to said first recliner mechanism includes fixing said first member for rotation with a locking mechanism of said first recliner mechanism.

12. The method of claim 11, wherein said assembling said first member to said first recliner mechanism includes providing a gap between an end of said first member and an outer surface of said first recliner mechanism to accommodate transverse movement of said first member relative to said first recliner mechanism.

13. The method of claim 1, wherein said assembling said second member to said second recliner mechanism includes fixing said second member for rotation with a locking mechanism of said second recliner mechanism.

14. The method of claim 13, wherein said assembling said second member to said second recliner mechanism includes providing a gap between an end of said second member and an outer surface of said second recliner mechanism to accommodate transverse movement of said second member relative to said second recliner mechanism.

15. The method of claim 1, wherein said adjusting includes telescoping one of said first and second members within the other of said first and second members.

16. The method of claim 1, wherein said positioning includes positioning said first recliner mechanism on a seat frame and positioning said second recliner mechanism on a seat frame.

17. The method of claim 1, wherein said positioning includes positioning said first recliner mechanism on a fixture and positioning said second recliner mechanism on a fixture.

18. The method of claim 17, further comprising assembling said first recliner mechanism and said second recliner mechanism to a seat frame after said relative position is achieved.

19. A dual recliner mechanism comprising:
a first recliner mechanism;
a second recliner mechanism;
a first member attached to said first recliner mechanism;
a second member attached to said second recliner mechanism and adjustably attached to said first member to define a position of said first recliner mechanism relative to said second recliner mechanism.

20. The dual recliner mechanism of claim 19, wherein said position is a radial position of one of said first recliner mechanism and said second recliner mechanism relative to the other of said first recliner mechanism and said second recliner mechanism.

21. The dual recliner mechanism of claim 19, wherein said position is a longitudinal distance between said first recliner mechanism and said second recliner mechanism.

22. The dual recliner mechanism of claim 19, wherein said first member is fixed to said second member once said position is achieved.

23. The dual recliner mechanism of claim 19, wherein said first recliner mechanism includes a first locking mechanism operable between an engaged position and a disengaged position and said second recliner mechanism includes a second locking mechanism operable between an engaged position and a disengaged position.

24. The dual recliner mechanism of claim 23, wherein said first locking mechanism is in said engaged position and said second locking mechanism is in said engaged position when said first member is adjusted relative to said second member.
